(19) United States
(12) Patent Application Publication
(10) Pub. No.: US 2014/0089008 A1
(43) Pub. Date: Mar. 27, 2014

(54) Data Handling System and Method

(71) Applicant: PicSafe IP Holdings Pty Ltd, Melbourne (AU)

(72) Inventors: Theodore Clyde Carner, Mt. Eliza (AU); David Hunter-Smith, Melbourne (AU); Raef Samuel Akehurst, East Melbourne (AU); Christopher Howard Gillard, Fairfield (AU)

(73) Assignee: PicSafe IP Holdings Pty Ltd, Melbourne (AU)

(21) Appl. No.: 14/037,607

(22) Filed: Sep. 26, 2013

(30) Foreign Application Priority Data
Sep. 26, 2012 (AU) 2012904211

(51) Int. Cl. G06Q 50/24; G06Q 10/00

(52) U.S. Cl. CPC G06Q 50/24; G06Q 10/00
USPC 705/3

(57) ABSTRACT

Disclosed herein is a device for capturing data relating to a person. The device includes a memory for storing instructions for executing a program and a processing system configured to execute the instructions. When the processing system executes the instructions the processing system is configured to record consent from a person to capture and/or transmit the data. In the event that consent has been recorded, the processor enables the data to be captured and/or transmitted. Also disclosed in a device that receives a first indication that the person has given their consent, the first indication being received in the form of biometric data; and receives a second indication that the person has given their consent. The device records both the first indication and the second indication of the consent. Also disclosed is a method controlling access to a digital image of a subject, a servicing system for handling data, and processor-executable instructions for configuring a device in accordance with the disclosure.

### FIELD OF THE INVENTION

The present invention relates to systems and methods for data handling. In one aspect, the invention is useful in the handling of data in the form of or relating to images. It will be convenient to describe the preferred embodiment of this aspect of the invention in the context of handling of medical images. However, it should be understood that the present invention is not limited to these fields of use and embodiments of it can be implemented in other fields.

### BACKGROUND OF THE INVENTION

In recent years the inclusion of high quality cameras in mobile telephones has greatly increased the ability of members of the public and professionals to take photographs in a wide variety of situations. The ease of taking photographs and the proliferation of cameras has meant that these digital imaging devices have become valuable tools in many fields. However, their use has greatly outstripped the abilities of individuals, businesses, government organisations and the legislature to regulate, or control the use of such cameras and the images taken with them.

Whilst the improper use of cameras and digital images can be a problem in the general population these problems can be amplified and added to in certain delicate circumstances. One such circumstance is the use of these convenient imaging devices in medical settings.

For example, consider a situation in which a patient who has an open wound presents at a hospital's casualty ward. In this situation, the first person to attend to the patient may be required to perform a triage process in which the condition of the patient is assessed and the seriousness of their condition determined. In some circumstances, however, the person performing triage may require assistance from specialist doctors. With the widespread possession of portable electronic devices which are capable of both data communication and high quality digital photography, eg. tablet computers, mobile telephones and the like, it is convenient for the person performing triage to photograph the patient's wound and forward this photographic image to the relevant specialist to have an initial assessment performed. This process is convenient for all parties involved, insofar as taking a photograph and forwarding it onto the specialist provides almost immediate access to the specialist's skills wherever that specialist is currently located, and increases the chance that the correct treatment will be provided to the patient as early as possible, thus improving their medical care. However, if one takes into account the broader context of this process many legal and ethical problems can arise.

Firstly, informed consent may, in some countries, be required from the patient in order to collect their personal information, ie to take a clinical photograph of them. This photograph then becomes part of their medical health record and therefore must be retained for a certain period of time by the hospital for their records and the patient medical records. In addition the photograph, forming part of the patient's personal record, may need to be accessible to the patient under privacy laws.

Where a relevant photograph is taken as part of the health care worker's employment and is part of their role under employment, the photographer's employer may own copyright in the image and, therefore, have the legal right to control the distribution and use of that image. Moreover, hospitals will have policies and ethical guidelines for handling this type of sensitive patient information that the healthcare worker now possesses.

To add to these legal and ethical concerns, as a practical matter, it should be noted that the device used to capture the photograph, more often than not, is the personal telephone or computing device of the healthcare worker taking the photograph. Also, once the photograph is taken it remains stored on the worker's device until it is deleted. This combination of features opens a potential avenue for accidental or deliberate misuse of these sensitive images. For example, in the event that the healthcare worker loses their device, whoever comes into possession of that device will come into possession of private and potentially sensitive images of patients. Moreover, there is also the potential for unauthorised and unethical sharing of the images by the healthcare worker for non professional purposes.

An additional layer of concern arises when one considers the use of the end photograph which is entirely uncontrolled in the exchange described above. Typically, the photograph taken by the person performing triage is simply emailed or attached to a digital message and forwarded on for review. The medical professional, their employer and the patient have no control over the use of that end image by its recipient, and the recipient's device has the same potential security, privacy and ethical flaws that the photographer's device has.

Accordingly, there is a need for a mechanism for handling potentially sensitive images or other data that addresses one or more of the problems described above.

Reference to any prior art in the specification is not, and should not be taken as, an acknowledgment or any form of suggestion that this prior art forms part of the common general knowledge in Australia or any other jurisdiction or that this prior art could reasonably be expected to be ascertained, understood and regarded as relevant by a person skilled in the art.

### SUMMARY OF THE INVENTION

In a first aspect of the present invention there is provided a device for capturing data, preferably including image data, relating to a person, the device including:

a memory for storing instructions for executing a program;

a processing system configured to execute said instructions, wherein when the processing system executes the instructions the processing system is configured to:

record consent from a person to capture and/or transmit the data; and
in the event that consent has been recorded, enable the data to be captured and/or transmitted.

In a preferred embodiment, the consent and enablement is to transmit the data. However, in another embodiment, the consent and enablement is to capture the data. In a further embodiment, the consent and enablement is to capture the data and transmit the data.

In one embodiment, the processing system is configured to: capture the data; record consent from the person to transmit the data; and in the event that consent has been recorded, enable the data to be transmitted.

Preferably, the device further includes a transmitter for transmitting the data, such as a picture or a video.

Preferably, the device further includes a camera for capturing the data.

Preferably, the device further includes a graphical user interface (GUI), wherein the processor is configured to display an electronic consent form on the GUI. The electronic consent form may, for example, include one or more of: an identification portion for identifying the person; a declaration portion for identifying what is being consented to; and an authorisation portion for recording that the person has given their consent.

Preferably, the GUI is a touch-screen, wherein the touch-screen is configured to receive an indication that the person has given their consent. The processing system may be configured to record the consent as a digital hand-created signature from a signature pad, the touch-screen or the like.

In an embodiment, the device includes a microphone for receiving audio data and/or a camera for receiving video data, and the processing system is further configured to enable the consent to be recorded as an audio and/or video recording. For example, the consent may be recorded as an audio recording, or a video recording with or without audio.

In an embodiment, the consent may be recorded as any combination of two or more of an audio recording, a video recording and a digital hand-created signature. In one embodiment, the consent is recorded as a digital hand-created signature and one or both of an audio recording and a video recording.

In an embodiment, when the processing system executes the instructions, the processing system is further configured to selectively record that the consent is for use of the data for one or more purposes.

Preferably, the processing system is further configured to receive a recipient identifier, wherein the recipient identifier identifies who may access the data. In an embodiment, processor is configured to link the recipient identifier with the data, for example by including the recipient identifier and the data in a common file to be transmitted upon the recording of consent.

Preferably, the processing system is configured to delete the data from the device once the data has been transmitted.

For example, the purposes may include one or more of: medical treatment of the person giving the consent; education and research; displaying in publications; sharing the data; displaying the data; viewing the data; storing the data; altering, updating and/or reordering the data; reformatting the data; and copying the data; and/or enabling the data to be available for any one or more of said actions.

Preferably, when the processing system executes the instructions, the processing system is further configured to generate a patient report for the person, wherein the patient report includes a representation of said data and said consent. The report may include one or more photos of the person and/or a portion the person. In one embodiment the report includes multiple photos of the person and/or a portion the person.

Preferably, the device is configured to transmit the data, patient report and/or recorded consent. Preferably the device is configured so that said transmission by a Hypertext Transfer Protocol Secure (HTTPS) connection. Preferably said connection is to an Application Server.

In one embodiment, the device is a mobile phone; computer tablet or portable computing device.

In another aspect of the present invention there is provided a servicing system for handling data, wherein the servicing system includes:

an application servicing system configured to:
(a) receive data including:
   image data relating to a person;
   consent data, which may include the data entered on an electronic consent form as described herein;
   a recipient identifier identifying one or more recipients that are allowed access to the image data;
(b) store the data in a data storage system;
(c) temporarily enable access to at least the image data to a person identified by the recipient identifier.

Preferably, the application servicing system is a web server.

Preferably, the received data is received from a device as described herein.

In one embodiment, the application is further configured to receive a sender identifier identifying from whom the data has been received, wherein the application server sends a URL address (eg a short URL) to the person identified by the sender identifier, the URL for accessing at least the image data. In one embodiment, the person identified by the sender identifier may share the access to further recipients. For example, the recipient identifier may forward the URL address to other people via electronic messaging.

The servicing system can be configured to: receive a request, from a person identified by the recipient identifier, to view at least the image data. The person identified by the recipient identifier may be the same person that was identified as identified by the sender identifier or may be a person with whom the access was shared.

In an embodiment, the temporary enablement of access is provided by enabling access for a predetermined time from a specified event. The specific event may be, for example, the request from the person identified by the recipient identifier.

In an embodiment, the application servicing system is further configured such that the temporary access to at least the image data is provided by allocating a dynamic URL address. The use of a dynamic URL assists in limiting the viewing and preserving the privacy of the data to be accessed. Further, the dynamically generated URL gives access to at least the image data and is only generated upon receiving the request from the person identified by the recipient identifier. The application server sends a link to the dynamic URL, to a recipient identifier identifying one or more recipients that are allowed access to the image data. However, in one embodiment, the link is sent to initiating user 30. In this case, as far as the server is concerned, the initiating user 30 is the intended recipient 40. That is, the recipient identifier is in this case the same as the sender identifier. Upon receiving the link, the initiating user can then sends the link to any further intended recipients.

In accordance with another aspect of the present invention, there is provided a method of controlling access to a digital image of a subject:
collecting, via an electronic consent form, permission data from the subject representing at least one permitted use of the image of the subject; and
in the event that the permission data has been collected, storing the digital image and the related permission data in a servicing system.

The image may be a photograph of a may be one of a plurality of images that constitute a video.

The method can further include, generating a temporary access address corresponding to the image to enable a recipient of the image to access the image from the servicing system. In one embodiment, the servicing system is accordance with the servicing system of the present invention. The step of generating a temporary access address corresponding to the image to enable a specified recipient of the image to access the image is preferably performed in response to the receipt of a request, by the recipient, to access the image the recipient.

The method can include changing the temporary access address corresponding to the image if at least one criterion is fulfilled. Said criterion could, for example, be time related, access related, user related etc. For instance a time related criterion could cause the temporary access address corresponding to the image to be changed after a predefined time period from an event (e.g. storage or first access) elapses. An access related criterion could cause the temporary access address corresponding to the image to be changed after the current temporary access address corresponding to the image has been accessed a certain number of times. A user related criterion could cause the temporary access address corresponding to the image to be changed a certain time after the current temporary access address corresponding to the image has been first accessed by a given user (e.g. determined by user ID, user IP address etc.).

Collecting permission data from the subject could include, generating a user interface on a display of an image capture device including a permission request. It could further include, receiving a user input on the image capture device to indicate a response to a permission request.

Multiple images can be stored together in a message relating to the subject. The permission data could relate to single images or all images in message.

In a further aspect of the invention there is provided a device including:

a graphical user interface (GUI);

a memory for storing instructions for executing a program;

a processing system configured to execute said instructions, wherein when the processing system executes the instructions the processing system is configured to:

display an electronic consent form on the GUI, the electronic consent from including: an identification portion for identifying the person; a declaration portion for identifying what is being consented to; and an authorisation portion for recording that the person has given their consent;

receive a first indication that the person has given their consent according to the declaration portion, the first indication being received in the form of biometric data;

receive a second indication that the person has given their consent according to the declaration portion, the second indication being of a different form to the first indication; and

record both the first indication and the second indication of the consent.

In some embodiments, the biometric data comprises the person's voice. In some embodiment, the second indication is a digital hand-created signature. The device may further be configured to capture data, preferably including image data, relating to a person, wherein the consent relates to at least one use of the data. In such embodiments, the device may include any of the features described herein in relation to the device of the first aspect of the invention.

In a further aspect of the present invention, there is provided a set processor-executable instructions for executing a program on a mobile smart device, wherein upon installation of the processor-executable instructions, the mobile smart device is configured to be any device that is in accordance with the present invention.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 illustrates an architecture exemplary of a data management system which, or a component of which, is in accordance with the present invention;

FIG. 2 illustrates graphical user interface screens for capturing data on a device in accordance with an aspect of the present invention;

FIG. 3 illustrates graphical user interface screens for obtaining consent to use the captured data, in accordance with an aspect of the present invention;

FIG. 4 illustrates graphical user interface screens for sending data, in accordance with an aspect of the present invention;

FIG. 5 illustrates a graphical user interface screen for viewing a report that has been generated in accordance with an aspect of the present invention;

FIG. 6 illustrates a graphical user interface screen for viewing further component of the report referred to in FIG. 5;

FIG. 7 illustrates graphical user interface screen for viewing a report, similar to FIG. 5, but being generated from an administrator account; and

FIG. 8 illustrates a pdf generated from the report referred to in FIG. 7.

### DETAILED DESCRIPTION OF THE EMBODIMENTS

The following description describes an exemplary architecture on which the present invention may be implemented. It is appreciated, however, that aspects of the invention may be implemented in sub-components of the architecture, rather than on the architecture as a whole.

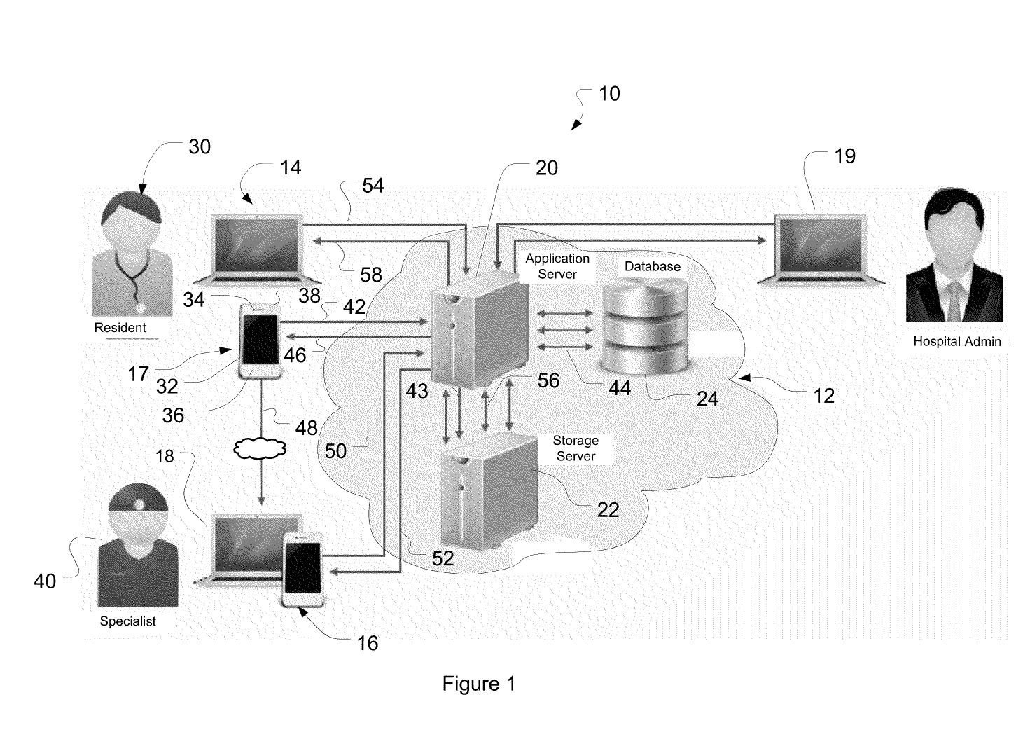

The architecture illustrated in FIG. 1 is of a data management system 10, which includes a servicing system 12 for servicing a plurality of user devices including personal computers 14, 18, 19 (such as desktops, laptops and notebooks) and mobile smart devices 16, 17 (such as smart phones and tablets).

The servicing system 12 includes an application servicing system, in the form of an application server 20, a data storage system, in the form of server 22, and a database system, in the form of database server 24. In other embodiments of the servicing system, one or more of the application servicing system, data storage system, and database system may be integrated on a single server.

The servicing system 12 acts as a cloud computing system through which users of the system may remotely utilise applications, and share, store and retrieve data via a web browser or front-end “app” operated on their local device, while the data storage and operation of the main application are conducted by the servicing system 12. In many cloud computing systems the local devices access the servicing system by a Hypertext Transfer Protocol (HTTP). However, in various embodiments of the present invention, information is exchanged between the devices and the servicing system by employing a more secure, Hypertext Transfer Protocol Secure (HTTPS) connection.

During operation of the data management system 10, the application server 20 receives user-created messages from a user's 30 smart device 17. The smart device has a memory and processor for storing and running software and applications, and in particular, a front-end “app” that runs on the device for accessing a web-based application that is hosted on the application server 20. The front-end app is used to operate the capture and transmission of data to the web-based application. The data that is captured can be comprised of a variety of types. In a particularly useful embodiment, the data includes digital image data captured on an inbuilt camera 34 on smart device 17. In addition or instead of capturing still photographs, the camera 34 may be configured to capture one or more series of images, each series of images collectively forming a video recording. The captured data may be temporarily stored in the memory of the smart device 17. The smart device also includes a microphone 36 that can capture audio recordings as the (or as part of the) captured data. A graphical user interface 32 is provided on the smart device so that the initiating user can view captured data and interact with the application. The GUI is preferably presented on a touch-screen of the smart device through which the initiating user 30 can operate the smart device and app thereon. The smart device also includes data communications system and antenna 38 for transmitting and receiving data. In the case of the smart device being a phone, the smart device can also send SMS or MMS messages or be used to make telephone calls.

To access the web-application, the initiating user 30 launches the local app on their smart device 17, and enters authentication information, including a user ID and password, to log onto a personal account of the initiating user 30. Details of the personal account are stored in the storage server 22, so that when the initiating user 30 enters their username and password, the app sends this information to the application server 20, which verifies that the username and password correlate to a valid account. Once authenticated, the user 30 can access data previously stored on their account or enter new data.

The data management system 10 can be used for a number of processes, three of which are explained below.

Process 1: Capturing and Transmitting Data

Once the initiating user 30 has logged onto their account, they can capture data on their smart device 17. The data can include image data, such as one or more photographic or video recordings of another person or a part of the person, and/or can include one or more audio recordings from the person. The initiating user 30 can, optionally, capture further data in the form of their own additional comments and information relevant to the person or the recorded data of or from the person. The further captured data can also include an identity of an intended recipient, or some identifier, such as a phone number, by which an intended recipient may be contacted by a messaging service.

Additionally, the app will ask for permission to use the location of the initiating user 30, the information being available on the smart device from a GPS hardware and software on the device. If the initiating user 30 grants permission to use the location, the app will include latitude and longitude coordinates with the data. Additionally, or alternatively, the user can enter a precise address or geographical identifier, such as the name of a specific hospital/room/ward etc.

The initiating user 30 can then use the app to send the captured data to the application server 20. However, before the app will allow the data to be transmitted, the initiating user 30 must first record that consent has been given by the subject of the data (e.g. pictures or video) to use the data. In other embodiments, the app is configured to require consent to be recorded before the app will enable capturing of data of or from the other person.

Once all data has been captured and consent for the use of the data has been recorded, the captured data is, at step 42, sent to and received by the application server 20 using an HTTPS connection. The application server stores the data on storage server 22 (step 43) and indexes the data (step 44), on database 24, so that the data may later be searched and selectively recalled. Additionally, the application server uses Google's Geocoding API to look up the encoded longitude and latitude coordinates associated with the data, thereby providing the suburb and country details.

At step 46, the application then sends a message to the initiating user 30, by any one or more of SMS, email and other messaging means, including a short URL address link via which a request to access the stored data may be lodged. The message also includes a summary stating the contents of the data, for example, summarizing that two photos have been taken and identifying the time and location from which the data was uploaded.

The initiating user 30 can then forward the URL link to the intended recipient 40 of the data, at step 48.

In another embodiment, the application server extracts the intended recipient 40 from the data sent by the initiating user 30, the identity of the intended recipient being encoded in an intended recipient identifier field of the data. The application server then sends a text message to the intended recipient 40.

The intended recipient 40, also being a user of data management system 10, has their user account username and password by which they can access the data that has been stored on the data server 22. The intended recipient, who has their own smart device 16, having the same functionality of smart device 17, or a personal computer 18, receives the URL link in the message. Upon “clicking” on the URL link, the intended recipient 40 is prompted to log onto their own user account, or accesses the URL via their own copy of the front-end app running on their device 16. Once logged in to the system, the intended recipient 40 is able to request access to the stored data, at step 50. The application server 20 then dynamically uploads the associated data stored on the storage server 22 and database server 24, to be available at a dynamically generated URL, so that the data can be viewed on device 16 or computer 18, at step 52.

The data viewed on the smart device 16 or computer 18 of the recipient 40, includes a link to contact the initiating user 30. By clicking (e.g. by executing the link via a mouse or by touching the link on the touchscreen), the recipient 40 of the data can contact the initiating user 30 by a phone call, email or SMS, as selected by the recipient 40 of the data.

Once the dynamically generated URL has been accessed and acknowledged by the intended recipient 40, then if the initiating user has requested a read-confirmation message, the application server 20 sends a message back to the smart device 17 of the initiating user 30 to inform them that the intended recipient 40 has viewed the data.

In some embodiments, the initiating user may select multiple intended recipients. In this case, the application server identifies each of the recipients that views the data. The identification of the recipient that views the data may be determined based on the known MAC address of the recipients device 16 to which the application server 20 sends the data.

In the event that the intended recipient 40 or recipients have not accessed the data with a set or selected time period from when the data was uploaded, then if the initiating user has requested a follow-up message (which in one embodiment, is achieved by requesting the read-confirmation message), initiating user 30 receives a message that the data has not been viewed by the intended recipient(s). The message may be initiated by the app or the application server 20 which records the time of the data upload to the application server. The app or application server 20 generates the message unless a read-acknowledgement is received by the intended recipient(s) within a set or selected time period. The message may be delivered by the app, a text message, email or any other smart device based messaging system. The app or application server 20 sends recurring reminder messages to the initiating user 30 until an intended recipient has accessed and acknowledged the data.

The message acts as a prompt for the initiating user 30 to follow up on the matter. Upon receiving the message the initiating user 30 is presented with an option to select one or more different or additional recipients who are then informed of the data upload and given access in the same manner as the original intended recipient 40.

For access security, the data is only available at the dynamically generated URL for a limited, predefined time, such as for 5 minutes or for a predetermined number of accesses, and access will only be granted to the IP address of the device from which the access request was sent (ie device 16 or computer 18). Thus, the dynamically generated URL is only temporarily accessible.

The application on the application server 20 also includes further security measures. For example:
Any user trying to randomly “guess” a URL can be detected, e.g. if a user incorrectly tries to access a URL more than a certain number of times e.g. 10, in a fixed period e.g. 24 hours, will be locked out for a time, e.g. 24 hours. An email will be sent to system administrator informing them of the suspicious behaviour. The administrator can, then, make an assessment as to whether the account should be suspended.
If a user's account is temporarily suspended in this way 3 times, their account will automatically be permanently suspended. The user would then have to contact the administrator to have the account re-enabled. This will prevent users from trying to access-restricted data.
For institutional users, data that has been accessed more than 5 times in a 24 hour period will have its URL changed. This is to prevent people from posting links on websites for multiple people to see. For private users the level could be, for example, 10 times in a 24 hour period. If the level is exceeded, the application on the application server 22 will email the user, warning them of a potential security breach.
All data stored on the storage server is “checksummed” and the checksum stored in the database.
All “private” data, i.e. data that requires consent from a person for capture, transmission or any other use (for example, image data), is stored on the storage server 22 with a non personally identifiable identification code. All personally identifiable data (for example, the person's name, date of birth, contact information) is stored as a record in database 24, so that it is separated from the private data. The record includes the non-personally identifiable identification code, so that the corresponding data on the storage server may be retrieved.

In another embodiment, the data is encrypted using a 3rd-party encryption protocol, such as an encryption protocol compatible with Argus or Healthlink proprietary software and systems for medical record management. The initiating user 30 can select that the data be sent to an Argus or Healthlink account or similar third party service, and enter an email address or other identifier associated with the account of a particular doctor, organization or other entity. The data is then encrypted using the relevant protocol used by the proprietary software and uploaded to a server that hosts the entered account. The user of the account may then access the data by logging onto their account and may save or replicate the data, as required, e.g. to store in a medical record. In another embodiment, the data may be uploaded to a 3rd-party secure content sharing account, such as a drop-box system, e.g. as provided by Box, Inc.

In some instances the device 17 of initiating user 30 may not be able to obtain access to the application server 20. For example, the device 17 may not have access to a functioning communications network, eg the network may be down, the device may not be able to communicate with the network, or the device may be in a remote area without network coverage. In such cases the app may operate in an off-line mode, so that the initiating user can at least still acquire data and maintain the data on their phone. To maintain security over the data, the app saves the data in an encrypted format onto the memory system of the device 17. The initiating user is required to enter a password to encrypt the data for saving onto the device's memory. The data can only be viewed or accessed from the memory by entering a password to decrypt the data, which in one embodiment is required to be the same password as the password used to encrypt the data. When the device 17 gains access to the application server 20, the initiating user can then decrypt the data, by entering the password, and upload the data to the application server 20.

In one embodiment, the data can be stored on the device 17, for some defined time period, e.g. 15 minutes, to allow the device 17 a time window within which the data may be uploaded to the application server 20. If the data still has not been uploaded by the expiry of the time window, the device 17 deletes the data from its memory system.

Process 2: Account Management by a User

Each time data is uploaded by an initiating user, a record is created in the database 24 for that data. A report may be generated the data, and preferably includes, in a single screen page, all of the data that has been captured by the initiating user for the particular person that is the source of this data.

The report could be compiled by, and viewed within, the app on the initiating user's smart device 17, prior to sending the data to the application server 42. Alternatively, the report can be created by the application server 42 upon receiving the data or upon retrieving the private data from the storage server 22 and the record from database 24. The initiating user may share the report by transmitting a copy to any one or more of: his/her own storage system; storage system(s) of other individual(s); and storage system(s) of organisation(s).

A user who initiates data and uploads it onto the servicing system 12, is able to view and search previous reports, edit or delete reports (if editing/deleting rights are granted to that user), or download a pdf version of a report. The application server 20 maintains an updated log of who has accessed the report and when, thus allowing the initiating user to check up on the progress of the report.

Once user 30 has logged into their account, they can, thereafter, log in (step 54) to a “bank” showing a list of all previous reports that they have uploaded. The user 30 can then locate and select a report from the list by using a search function within the app. The application server 20, then retrieves the selected report from the storage server 22, at step 56, and sends the report to the user 30 at step 58. Depending on the data contained in the bank list, the search function can either be performed locally, on the device, or by the servicing system 12, using the application server 20 and database server 24.

Process 3: Account Management by an Administrator

An administrator 19 of data management system 10 may also manage the reports. The administrator can access the reports in the same manner as described in process 2, but the “bank” of reports viewed upon login includes all users, rather than being limited to any one initiating user. The administrator is also granted increased access rights, being able to edit, delete and/or forward any records as required, but consistent with the rights of use to which consent has been recorded. All such activities, as with individual users, is recorded in the updated log associated with that particular record.

An Exemplary Application

The data management system 10 may be used in a variety of sectors and by a number of institution types. For example, the data management system could be used in law enforcement, by a police department, or in the insurance, building, inspection, or journalism industries—to name a few.

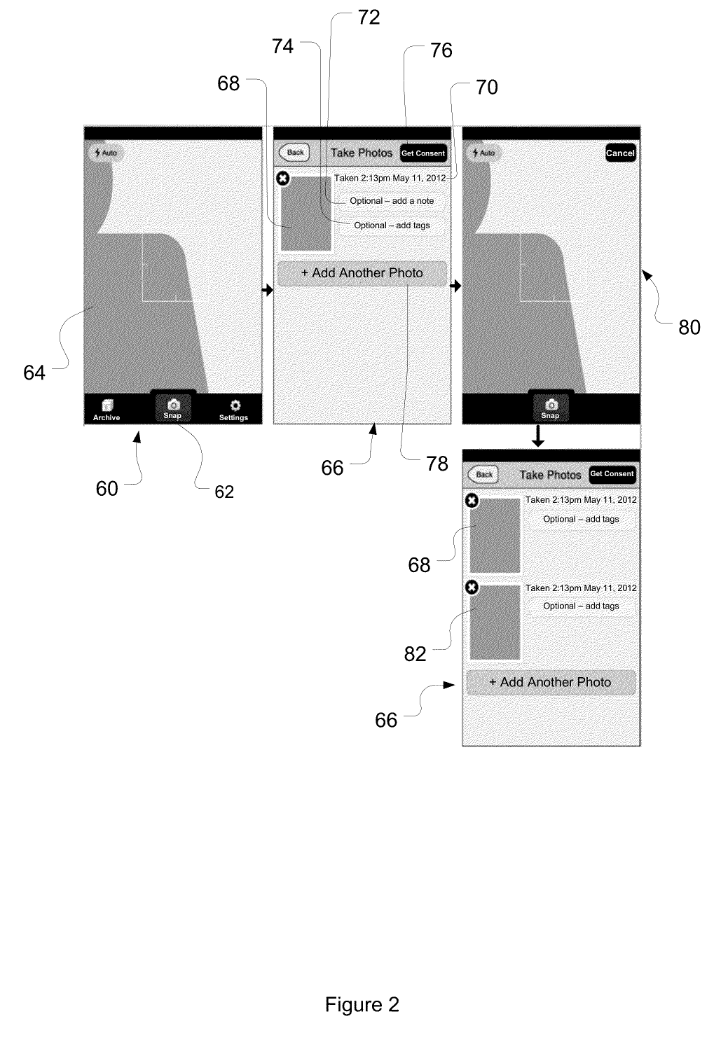

FIGS. 2 to 8 will be used to illustrate an embodiment of certain aspects of the present invention by illustrating an exemplary use of the system.

In a particularly useful application, hereinafter described, the data management system is used by a hospital or network of hospitals. The administrator 19 is, in this case, an authorized person from the hospital's administration. The administrator requires detailed records to be kept for each patient, and must ensure compliance with certain regulatory legislation. For example, in the United States of America, there is a requirement to comply with the Health Insurance Portability and Accountability Act (HIPPA).

An exemplary scenario faced at the hospital is that of a patient who has suffered a laceration and is being seen by a resident doctor in a casualty ward. The resident seeks direction from a specialist, but the specialist has finished their shift and has returned to their home. The resident wishes to capture data, in the form of an image of the patient's wound, and send it to the specialist in order to obtain diagnostic and treatment guidance.

In this case, the patient is the subject of captured data, and from whom consent to use the data is required. The creation, transmission, access, storage and maintenance of records within the hospital can be achieved by the data management system 12, as described above. In this scenario, the resident is the initiating user 30 who captures data with respect to another person (the patient), this data being an image of the patient's wound and further particulars such as the patient's name, age, gender and general health, a description of surrounding circumstances and any other relevant comments or information. The intended recipient is thus a particular specialist, perhaps a specialist currently in-hospital or on-call but not immediately available to physically attend the patient.

Upon remotely obtaining access and viewing the report on their smart device 16, the specialist is able to call or message the resident with comments as to the priority and immediate instructions for attending to the patient's wound.

The User Interface

Upon logging into the app on their device 17, the resident will be presented with a user interface 32 in which the device 17 is configured into a mode for taking photographs. This is illustrated in the first user interface configuration 60 in a series of four consecutive configurations shown in FIG. 2. In configuration 60, the resident takes an image by selecting a “snap” icon 62 on the interface, resulting in the photographic capture of the image 64 displayed on a portion of the interface. The user interface 32 then progresses to a preview configuration 66, which shows a thumbnail 68 of the captured image, with a time stamp 70. The resident then has the option to select comments field 72 or tag field 74 to add further comments in relation to the image represented in thumbnail 68. If the resident is satisfied with the photo, they may proceed with obtaining consent from the patient by pressing (ie “clicking”) a “Get Consent” icon 76. Alternatively, the resident can take further photos by pressing an add-image button 78, in which case the user interface again progresses to a camera interface mode 80 similar to the initial camera interface mode 60. Upon taking a second photo, the user interface 32 returns to the preview configuration 66, but this time showing the first thumbnail 68 of the first photo, together with a second thumbnail 82 of the second image. Adjacent to each thumbnail are displayed corresponding comments, tags and timestamp fields. Further images may be taken in this same manner, and the resident can progress to the consent acquisition step, once sufficient photos have been captured.

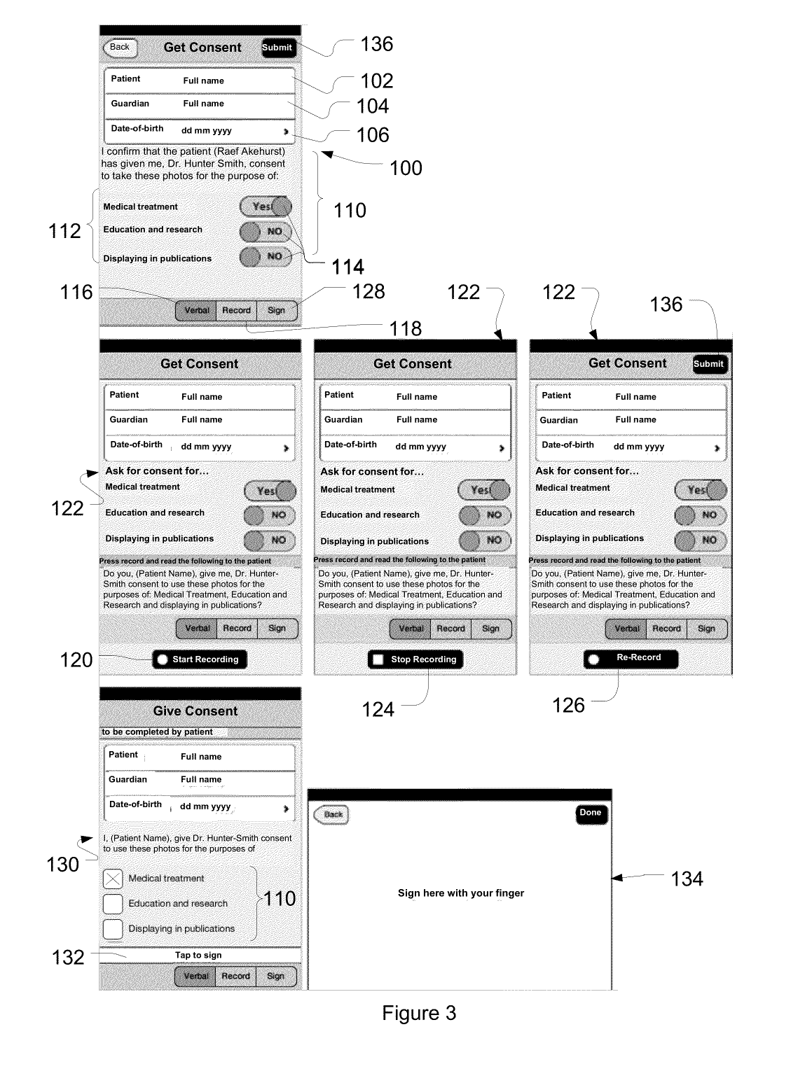

FIG. 3 shows a series of user interface screens for obtaining consent. The user interface will initially display screen 100 having fields 102, 104 and 106 for entering, respectively, the patient's name, any guardian's name (if the patient is not of a legal age or otherwise incompetent to give consent), and the patient's date of birth. In one embodiment, in addition to or instead of guardian field 104, display screen 100 includes a translator field (not shown) for entering the name of a translator responsible for communicating with the patient and translating consent-relevant information to the patient's language, if required.

In one embodiment, the patient's name is automatically entered into the patient-name filed 102 by selecting an option (not shown) on the user interface to identify the patient by scanning a visual patient-identifying marking, such as a barcode. Upon selecting this option, a scanner (eg a barcode scanner) interface opens in the app. The camera 34 on the smart device 17 captures an image of the marking displayed on an item worn by the patient. In other embodiments the marking may be physically associated with the patient in other ways. The marking contains information indentifying the patient. In the case of the marking being a barcode, the processor on the device 17 decodes the barcode to extract the information contained therein. The device 17 enters any relevant information from the marking, such as the patient's name, into the associated fields on the display screen 100,

When obtaining consent, the interface 32 also displays a declaration 110 of what is being consented to, the declaration including the initiating user's name (ie, the resident's name, in this case), the name of the person giving consent (ie the patient or the patient's guardian) and a list of items 112 to which consent is being given. Each of the items 112 can be selected or de-selected by corresponding yes/no selection boxes 114. In this manner, the boundaries of consent can be tailored to provide flexibility to the circumstances and the desires of the patient. For example, as indicated in FIG. 3, the bounds of consent can be restricted to any or more of (i) medical treatment of the person giving the consent; (ii) education and research; (iii) and displaying in publications, with only medical treatment having been agreed to by the patient. In other embodiments, consent may be selected from any one or more of the following actions: sharing the data, displaying the data, viewing the data, storing the data, updating or reformatting the data, and copying the data; and/or making the data available for any combination of these actions.

Consent may also be given in a variety of ways. The user interface illustrated in FIG. 3 enables the resident to obtain consent by one or more of the three ways discussed below, which may be selected depending on the legal requirements of the jurisdiction and/or the physical state of the patient. In an embodiment, prior to obtaining consent, the wording for the consent can be changed.

Option 1:

Verbal consent, or more precisely, confirmation of verbal consent. With this option the initiating user/resident confirms that patient/guardian has given their verbal consent. This is the default option, and is indicated by screen 100. The selection of this option is indicated by highlighting or greying-out of a corresponding selection box 116 labelled “Verbal”.

Option 2:

Recorded verbal consent in which the initiating user/resident records, an as audio and/or video recoding, a reading of a statement to patient/guardian followed by the patient/guardian's stating “yes”. This option is selected by engaging a “Record” box 118, which results in a “Start Recording” box 120 being displayed on the “Record” screen 122. Upon selecting “Start Recording”, commencement of recording occurs, and the box 120 is replaced with a “Stop Recording” box 124. Upon stopping the recording, a “Re-Record” box 126 will appear to allow re-recording if the first recording was unsatisfactory. Recorded verbal consent is advantageous providing biometric authentication of the person giving the consent, by identifying the person by their unique characteristics or traits, in this case their distinctive voice and/or visual appearance. In other embodiments, additional or alternative biometric authentication may be used, such as fingerprint capture.

Option 3:

Signed consent in which the patient/guardian provides a signature on the touch screen or other interface capable of reading handwriting or similar gestures. If, the “Sign” box 128 is selected instead of the “Verbal” or “Record” box, then the interface will present a “Sign” screen 130. In this case, the patient/guardian taps a sign box at the bottom of the declaration statement 110, which advances the user interface to a blank signature screenpage 134 upon which the patient/guardian can sign their signature using their finger (or a stylus) on the touchscreen.

The app may remember the last used consent type and default to that the next time the app is used.

In some embodiments, the app configures the device 17 to prompt the user/resident to obtain consent by two or more of (i) confirmation of verbal consent, (ii) recorded biometric consent and (iii) signed consent. In one embodiment, the device 17 is configured by the app to obtain consent by (i) confirmation of verbal consent or, more preferably, a signed consent and (ii) at least one additional form of consent based on biometric authentication, such as recorded verbal consent. In this case the app only records the consent as being complete once both the signed or confirmed consent and the biometric consent has been acquired. The requirement of the signed or confirmed consent plus a biometric form of consent may provide the completed consent with a more binding or stronger legal standing compared with only a single form of consent. This may prove important should the patient, at some later time, deny having properly considered the giving of their consent and/or deny having given their consent at all.

Once consent has been recorded (i.e. captured by device 17), the a submit box 136, as indicated on screens 100 and 122, may be selected to progress to select options for sending the message to the specialist and for concluding the submission by finally sending the message.

In one embodiment, the consent captured by the device 17 may relate to other permissions or agreements to which the patient's consent is required. For example, the consent may be for a medical procedure for which a patient's informed consent and acceptance of any associated risks is required. The captured electronic consent form may optionally be uploaded to an Argus or Healthlink record management system, a drop box system or to any other data storage system, and stored as a single file. The captured consent form may be handled by the device, in terms of security features, storage and transmission, in the same manner as described herein in relation to image or other data to which consent for a use is given by the patient. Additionally, the handling of consent as described herein may apply to consent from people other than patients.

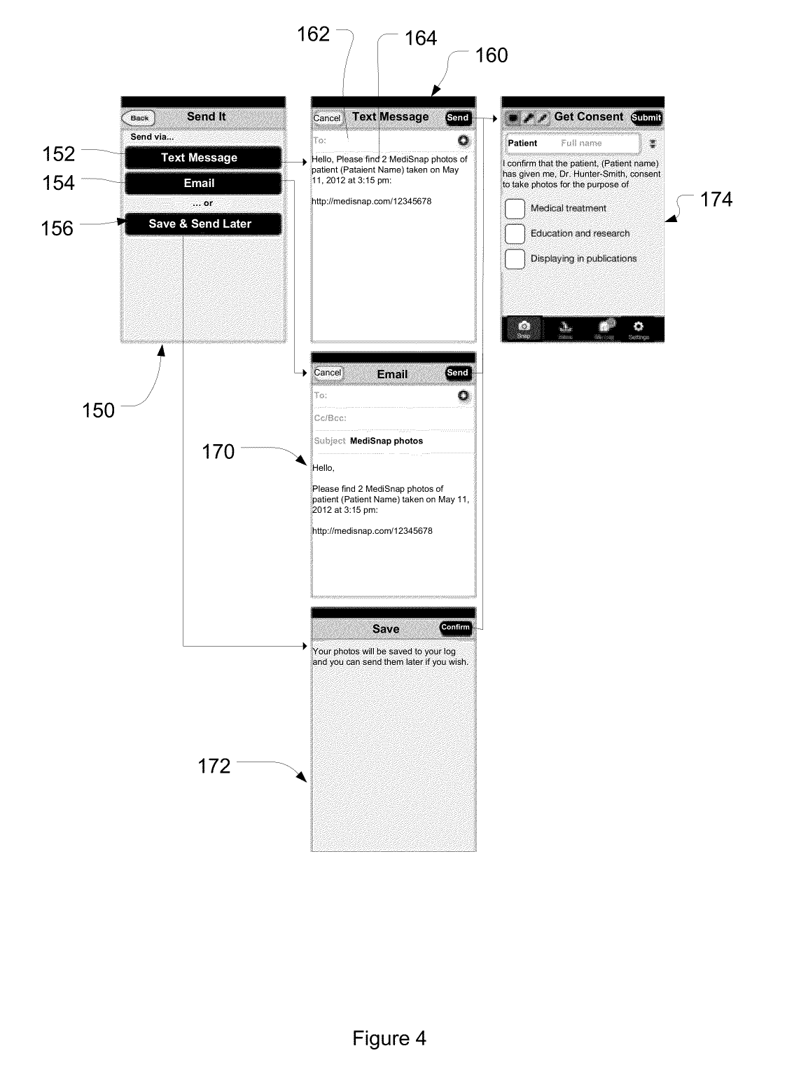

Exemplary user interface screens for sending the message are illustrated in FIG. 4. The user is initially presented with a first screen 150 displaying respective boxes for sending the message by text message 152, email 154 or to save the message and send it later 156.

If sending by text message, screen 160 is presented on the user interface. The screen 160 includes a “To” field 162 into which the user selects the name of the specialist or other intended recipient(s) from the address book on their smart device 17. The screen 160 also includes an automatically generated text message stating the number of photos that have been taken, the time and location of the photos and the short URL address to request the photos, consistent with the description in process 1, above. The user may modify the text in the same manner that they would normally edit a text message on their smart device.

If sending by email, the automatically-generated text is inserted into a draft email, instead of a text message, as illustrated in screen 170. In this mode, the user can assign “cc” and “bcc” recipients for the email.

The user may alternatively choose, via interface screen 172, to save the data for sending at a later stage. The data will then be saved to storage server 22 and database 24, for later retrieval and completion of the sending process. If the user has not yet successfully recorded the consent, then the interface will return to a “Give Consent” screen 174 from which the previously-described consent user interface may be accessed.

To discourage unapproved use of the captured data, the data is not stored on the initiating user's device 17 (nor the intended recipient's device 16). There is no data-retention capacity for smart devices within the application's function and all such sensitive is only stored on storage server 22 and database 24.

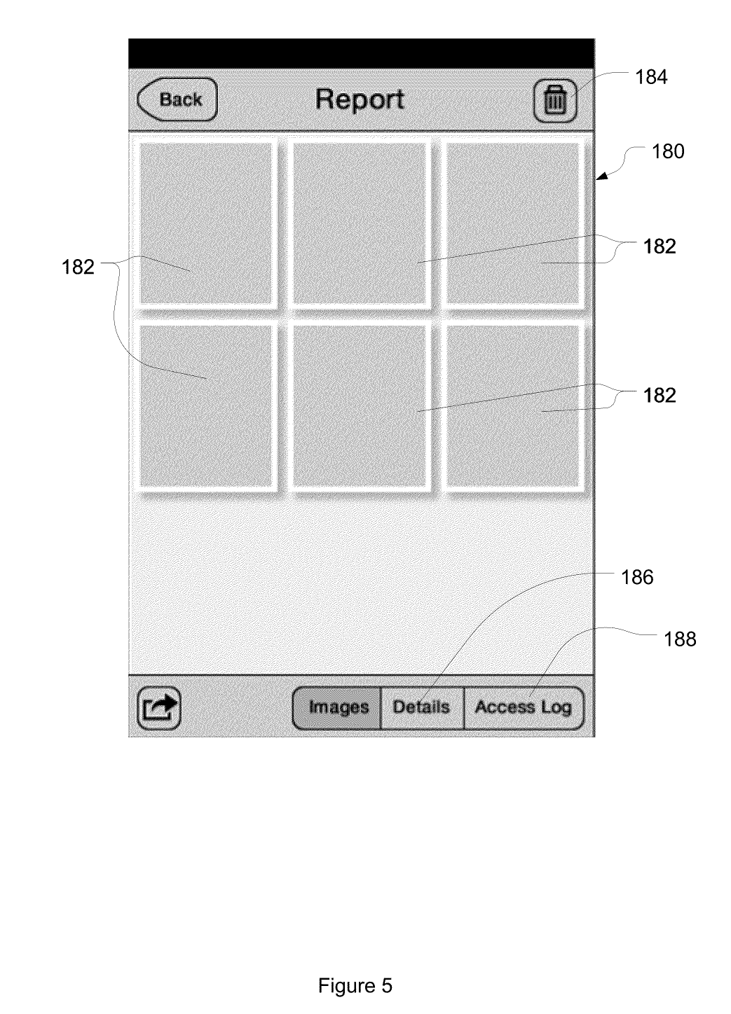

Any data saved to the storage server 22, regardless of whether or not the user sends that data to the final recipient, is automatically included into a report and archived. To gain access to an archived report, a person must enter a password. In one embodiment, the generated report may be, at the initiating user's choice, automatically shared to at least one email address. When a person with a user account and access to a report (such as the initiating user and the intended recipient via legitimate URL) opens the report, they are presented with a default report screen 180 as illustrated in FIG. 5. The default report screen shows thumbnails 182 of each image recorded in the report, which may be selected to view enlarged pictures of the corresponding selected thumbnail. In FIG. 5, a delete button 184 is illustrated on the screen. This button may be used to delete a report, but it is noted that in regulated environments in which reports must be maintained, such as in a hospital environment, such a deletion option will not be available. From screen 180, the user may view report details by selecting button 186, or view a log of who has accessed the report and when, by selecting button 188.

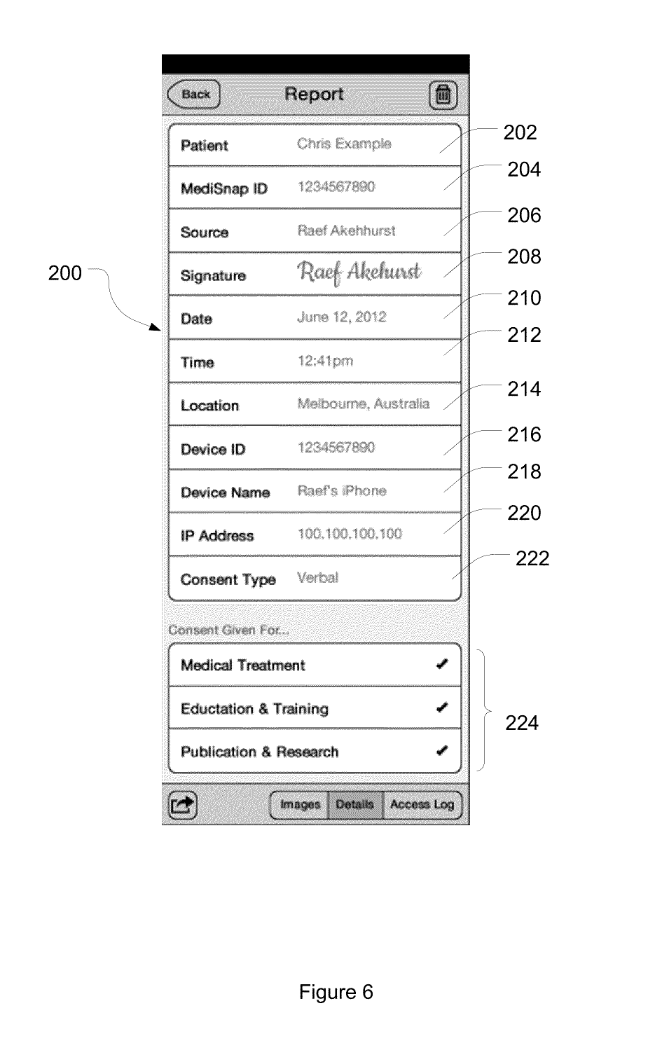

The report details are provided in a separate screen 200, as illustrated in FIG. 6. The report details include, for example:
the patient's name 202;
the patient's guardian name, if relevant (not shown);
a record/report number 204;
the initiating user 206;
a digitally recorded signature 208 of the initiating user, which is stored in the initiating user's user account data;
the data of the report 210;
the time 212 at which the report was last completed;
the location 214 at which the report was generated;
an identification 216 of the device that generated the report, such as the device's MAC address;
the name 218 of the initiating user's device, the name being the name of the device as recorded in the device's configuration data, or as otherwise entered in the user's account information;
the IP address 220 of the initiating user's device;
the type of consent 222 recorded; and
a list 224 of for what consent has been recorded;

As mentioned, all users, including admin users within an institutional setting where records maintenance must be maintained, users (including admin users) are not provided with a “Delete Record Button”. Typically, “Download Pdf” buttons, and “Publication and Research” consent buttons are also not offered to such institutional users. This is because, in such circumstances, publication and research are atypical for standard consent agreements, and not required in emergency situations. Furthermore, the pdf access is limited to safeguard against data being copied or distributed beyond what can be controlled by the servicing system 12.

However, such institutional users are provided with the following additional details in the report:
a facility ID, ie the name of the institution;
a staff ID, such as an employee number issued by the institution for the initiating user; and
an email by which the initiating user can be contacted.

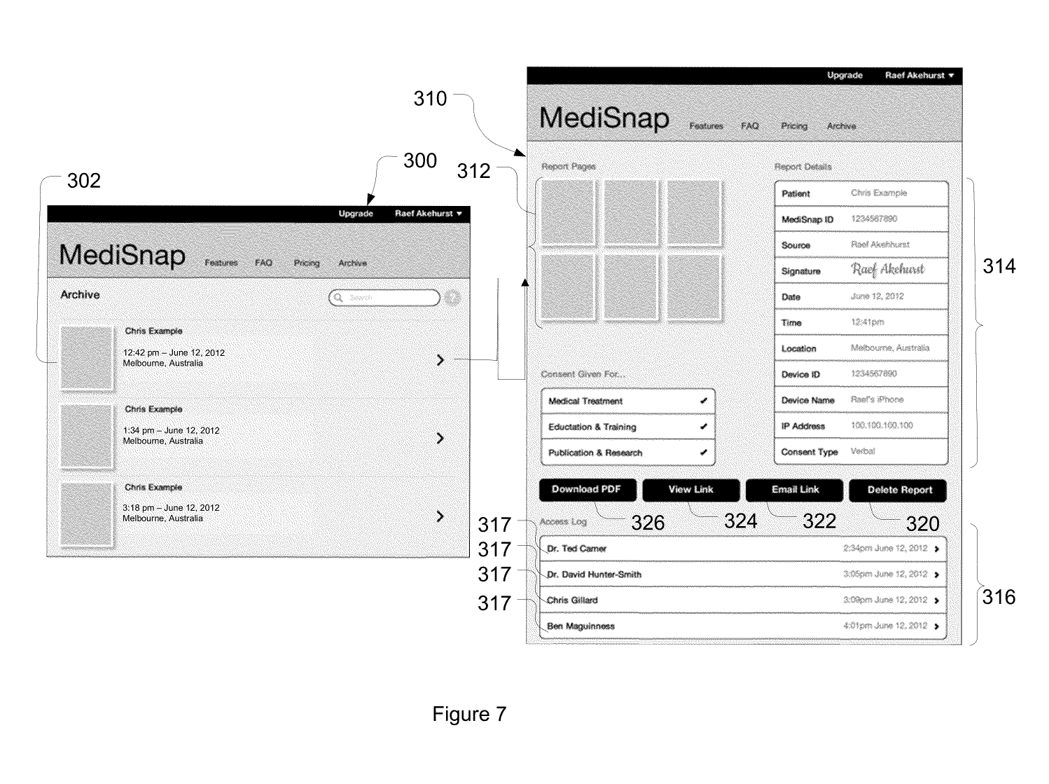

Administration staff will typically interact with the serving system 12 via a personal computer 19, rather than a smart phone or other compact portable smart device. Therefore, the user interface on such a computer can conveniently provide more information than on the small screen of a smart phone. As illustrated in FIG. 7, upon accessing archived records stored in the record bank and selecting a specific record 302, as illustrated in screen 300, the user interface presents a summary of all report information on a single summary screen 310. The summary screen 310, thus, presents image thumbnails 312, report details, 314 and access log details 316. By selecting any one of the log entries, further details pertaining to the logged access are provided on a further screen (not shown). The further details include statements of the IP address, MAC address, name of the device used to gain the access, and the location (longitude and latitude) from which the access was gained. Additionally, if permitted by the institution, one or more further function buttons are provided on summary screen 310. In summary screen 310 there is provided:
a delete report button 320;
an email link button 322, to enable the report to be forwarded to a recipient;
a view link button 324, to view the URL presently associated with the report; and
a download pdf button 326, to generate a pdf of the report for printing.

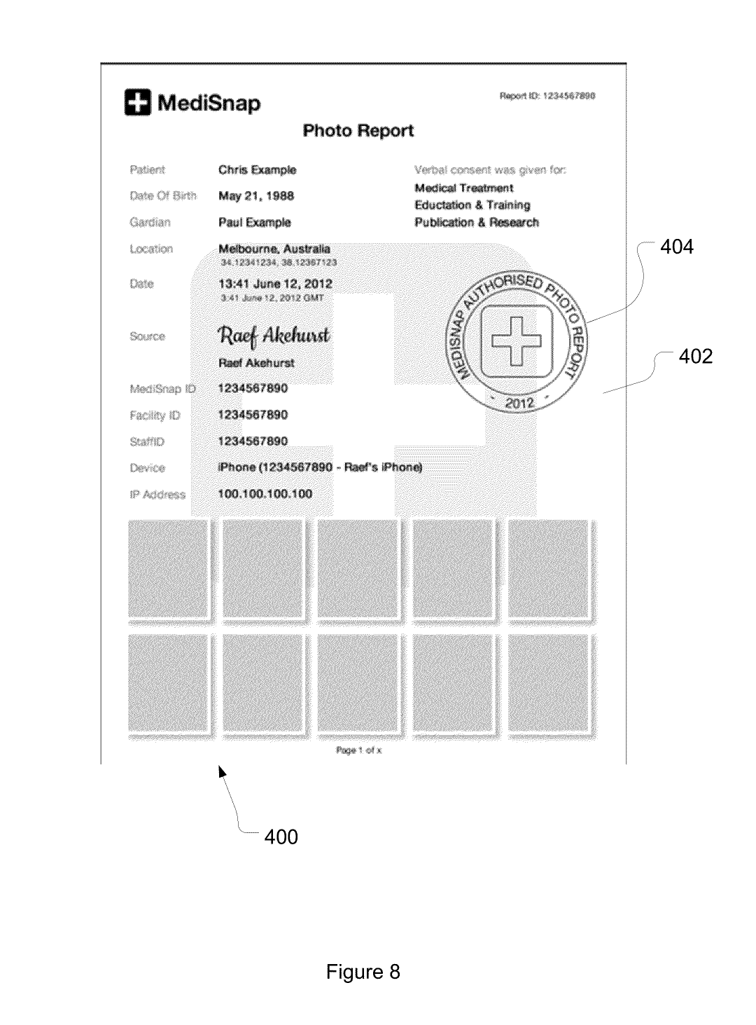

FIG. 8 illustrates an example of a report generated as a pdf 400. The information content of the report includes all the same data available on the electronic report described above, but further includes a watermark 402 and stamp 404 associated with the application or relevant institution. A second page of the pdf report (not shown) provides a summary of the access log, listing details as above described.

It will be understood that the invention disclosed and defined in this specification extends to all alternative combinations of two or more of the individual features mentioned or evident from the text or drawings. All of these different combinations constitute various alternative aspects of the invention.

What is claimed is:

1. A device for capturing data relating to a person, the device including:
a memory for storing instructions for executing a program;
a processing system configured to execute said instructions, wherein when the processing system executes the instructions the processing system is configured to:
record consent from a person to capture and/or transmit the data; and
in the event that consent has been recorded, enable the data to be captured and/or transmitted.

2. The device of claim 1, wherein the device further includes a camera for capturing the data.

3. The device according to claim 1, wherein the device further includes a graphical user interface (GUI), wherein the processor is configured to display an electronic consent form on the GUI, the electronic consent form including: an identification portion for identifying the person; a declaration portion for identifying what is being consented to; and an authorisation portion for recording that the person has given their consent.

4. The device according to claim 3, wherein the GUI is a touch-screen, wherein the touch-screen is configured to receive an indication that the person has given their consent, the processing system being configured to record the consent as a digital hand-created signature from a signature pad or the touch-screen;

5. The device according to claim 1, wherein the device includes a microphone for receiving audio data and/or a camera for receiving video data, and the processing system is further configured to enable the consent to be recorded as an audio and/or video recording.

6. The device according to claim 1, wherein:
the device further includes a graphical user interface (GUI), wherein the processor is configured to display an electronic consent form on the GUI, the electronic consent form including: an identification portion for identifying the person; a declaration portion for identifying what is being consented to; and an authorisation portion for recording that the person has given their consent, GUI being a touch-screen configured to receive an indication that the person has given their consent, the processing system being configured to record the consent as a digital hand-created signature from a signature pad or the touch-screen; and
the device includes a microphone for receiving audio data and/or a camera for receiving video data, the processing system being further configured to enable the consent to be recorded as an audio and/or video recording;
wherein the device is configured to enable consent to be recorded as both (i) an audio and/or video recording and (ii) a digital hand-created signature.

7. The device according to claim 1, the processing system is further configured to:
receive a recipient identifier, wherein the recipient identifier identifies who may access the data; and
link the recipient identifier with the data.

8. The device according to claim 1, wherein the device includes a transmitter and the device is configured to transmit the recorded consent and at least one of (i) the data and (ii) a patient report, wherein the patient report is generated by the device to include a representation of said data and said consent.

9. The device according to claim 8, wherein the data comprises multiple image-based recordings of the person and/or a portion the person, wherein the image-based recordings include photos and/or video recording, or the image-based recordings are photos.

10. The device according to claim 8, wherein the device is configured so that said transmission by a Hypertext Transfer Protocol Secure (HTTPS) connection.

11. The device according to claim 8, wherein the processing systems is configured to erase the data once the data has been transmitted.

12. The device according to claim 1, wherein the processing system is configured to temporarily store the data in an encrypted format on the device for a defined time period, and wherein if the data is still stored on the device at the expiry of the defined period, the processing system is configured to erase the data from the device.

13. The device according to claim 1, wherein the processing system is configured to: capture the data; record consent from the person to transmit the data; and in the event that consent has been recorded, enable the data to be transmitted.

14. A device including:
a graphical user interface (GUI);
a memory for storing instructions for executing a program;
a processing system configured to execute said instructions, wherein when the processing system executes the instructions the processing system is configured to:
display an electronic consent form on the GUI, the electronic consent from including:
an identification portion for identifying the person; a declaration portion for identifying what is being consented to; and an authorisation portion for recording that the person has given their consent;
receive a first indication that the person has given their consent according to the declaration portion, the first indication being received in the form of biometric data;
receive a second indication that the person has given their consent according to the declaration portion, the second indication being of a different form to the first indication;
record both the first indication and the second indication of the consent.

15. A device according to claim 14, wherein the biometric data comprises the person's voice.

16. A device according to claim 14, wherein the second indication is a digital hand-created signature.

17. A device according to claim 14, and wherein the device is further configured to capture data relating to the person, wherein the consent includes consent for at least one use of the data, wherein in the event that consent has been recorded, the device is configured to enable the data to be captured and/or transmitted.

18. A servicing system for handling data, wherein the servicing system includes:
an application servicing system configured to:
(a) receive data including:
image data relating to a person;
consent data representing at least one use of the image data permitted by the person;
a recipient identifier identifying one or more recipients that are allowed access to the image data;
(b) store the data in a data storage system;
(c) temporarily enable access to at least the image data to a person identified by the recipient identifier.

19. The servicing system of claim 18, wherein the application servicing system is configured to: receive a request, from a person identified by the recipient identifier, to view at least the image data.

20. The servicing system of claim 18, wherein the application servicing system is further configured such that the access to at least the image data is provided by allocating a dynamic URL address.

21. The servicing system of claim 18, wherein the application servicing system is further configured to receive a sender identifier identifying from whom the received data was received, wherein the application server sends a URL link, for accessing at least the image data, to the person identified by the sender identifier.

22. The servicing system of claim 21, wherein the recipient identifier identifies the one or more recipients that are allowed access to the image data as being a person who accesses the URL link.

23. A method of controlling access to a digital image of a subject:
collecting, via an electronic consent form, permission data from the subject representing at least one permitted use of the image of the subject; and
in the event that the permission data has been collected, storing the digital image and the related permission data in a servicing system.

24. The method of claim 23, wherein the method further comprises generating a temporary access address corresponding to the digital image to enable a specified recipient of the digital image to access the digital image from the servicing system.

25. The method of claim 24, wherein the step of generating a temporary access address corresponding to the digital image to enable a specified recipient of the digital image to access the digital image is performed in response to the receipt of a request, by the recipient, to access the digital image.

26. The method of claim 23, wherein the servicing system is in accordance with claim 18.

27. A set processor-executable instructions for executing a program on a mobile smart device, wherein upon installation of the processor-executable instructions, the mobile smart device is configured to be a device in accordance with claim 1.

28. A set processor-executable instructions for executing a program on a mobile smart device, wherein upon installation of the processor-executable instructions, the mobile smart device is configured to be a device in accordance with claim 14.
